(19) United States
(12) Patent Application Publication
(10) Pub. No.: US 2026/0151718 A1
(43) Pub. Date: Jun. 4, 2026

(54) FILTER

(71) Applicant: GUANN MING TECHNOLOGY CO., LTD., TAINAN CITY (TW)

(72) Inventor: CHIH-PING WEI, TAINAN CITY (TW)

(21) Appl. No.: 18/966,750

(22) Filed: Dec. 3, 2024

(51) Int. Cl. B01D 39/18; B01D 46/00; B01D 46/52

(52) U.S. Cl. CPC B01D 39/18; B01D 46/0005; B01D 46/521; B01D 2239/0283; B01D 2239/0654; B01D 2265/04; B01D 2265/06

(57) ABSTRACT

A filter having a frame, a support mesh, and a filtering netlike body is provided. The frame having an internal space therein includes a plurality of support bars connected to a peripheral frame and located at two areas defined by the peripheral frame. The support mesh and the filtering netlike body are mounted in the space. The frame, the support mesh, and the filtering netlike body are made from waste fiber composite containing fibrous bodies and adhesives. A weight percent of the fibrous bodies is no less than 95% but less than 100% while the residual weight percent is the adhesive. The fibrous bodies come from residual or recycled waste containing fibers pulverized into fibers like cotton wool. A size of the fibrous body is 0.1 mm-50 mm and the adhesive is acrylates copolymer. Thereby the filer can be recycled directly, without separating respective components from one another.

### BACKGROUND OF THE INVENTION

### Field of the Invention

The present invention relates to a filter, especially to a filter used in filter equipment.

### Description of Related Art

In order to remove dust and particles efficiently and keep the environment dust-free, places including hospitals, pharmaceutical factories, spray booths, office buildings, factories, clean rooms, computer rooms, etc. or machines such as gas turbine engines where highly clean air is required or no fiber is allowed to fall off are equipped with air filters. The air filter includes an air handling unit and filter cotton disposed on an inlet.

The common filter cotton is made of non-woven fabric formed by fiber or yarn strips bonded together by mechanical, chemical, heat or solvent treatment. Owing to special formation way, the non-woven fabric has poor performance in tensile strength and shear deformability. Thus the non-woven fabric is often connected with a metal mesh with a fine mesh size having good structural strength to protect the non-woven fabric from damages during filtration operation of filtration equipment. Thereby filtration efficiency will not be affected.

That means a conventional filter is composed of a frame, a metal mesh, and filter cotton. The filter cotton is disposed on one side of the metal mesh and the frame is arranged at the periphery to prevent the metal mesh and the filter cotton from separating from each other. The damages of the filter cotton can be avoided due to the metal mesh used for supporting the filter cotton.

However, another problem is derived from the above design. The metal mesh and the filter cotton in the filter already used need to be separated for waste sorting and recycling before disposal. Thus the recycling process of the filter is not only complicated and inconvenient, but also labor and time intensive.

Thus there is room for improvement and there is a need to provide a novel filter.

### SUMMARY OF THE INVENTION

Therefore, it is a primary object of the present invention to provide a filter which includes a support mesh not only providing sufficient support to a filtering netlike body and protecting the filtering netlike body from damages, but also able to be disposed and recycled together with a frame and the filtering netlike body directly, without additional dismantling and sorting processes.

It is another object of the present invention to provide a filter which includes a frame, a support mesh, and a filtering netlike body. Fibrous bodies contained in the frame, the support mesh, and the filtering netlike body come from residual or recycled waste containing fibers. Thereby not only the waste containing the fiber can be recycled, the use of the waste is also environmental-friendly.

In order to achieve the above objects, a filter according to the present invention mainly includes a frame, a support mesh, and a filtering netlike body.

The frame consists of a peripheral frame and a plurality of support bars. The support bars are disposed on an area surrounded by the peripheral frame and connected to the peripheral frame. The peripheral frame and the plurality of support bars work together to define a cuboid having an internal space.

The support mesh is mounted in the space of the frame and leaning against the support bars.

The filtering netlike body is also arranged in the space of the frame and stacked over the support mesh. A periphery of the support mesh and a periphery of the filtering netlike body are both fixed by the peripheral frame of the frame.

The frame, the support mesh, and the filtering netlike body are all made from waste fiber composite whose total weight is given as 100 percent. The waste fiber composite includes fibrous bodies with a weight percent of no less than 95% but less than 100% and at least one adhesive having the residual weight percent. The fibrous bodies are coming from residual or recycled waste containing fibers which are pulverized into a form of fluffy cotton wool. A size of the fibrous body is ranging from 0.1 mm to 50 mm and the adhesive is acrylates copolymer.

Preferably, the support mesh is stacked over at least one surface of the filtering netlike body.

Preferably, the support mesh is stacked over each of two opposite surfaces of the filtering netlike body.

Preferably, the support mesh is in a flat form.

Preferably, the support mesh is corrugated.

Preferably, the filtering netlike body is in a flat form.

Preferably, the filtering netlike body is corrugated.

The present filter has the following advantages.

The frame, the support mesh, and the filtering netlike body of the filter are all made from waste fiber composite. Along with different amount of the fibrous bodies and the adhesives added, the waste fiber composite has different hardness and flexibility. Thereby the frame, the support mesh, and the filtering netlike body formed respectively can have good hardness, support, and deformability according to their states in use required.

The frame, the support mesh, and the filtering netlike body are all made from waste fiber composite. Thus there is no need to spend time and labor on breaking down the filter into the frame, the support mesh, and the filtering netlike body during waste recycling. The filter can be disposed and recycled directly. This is convenient, time-saving, and labor-saving.

### BRIEF DESCRIPTION OF THE DRAWINGS

FIG. 1 is a schematic drawing showing a perspective sectional view of an embodiment according to the present invention;

FIG. 2 is a perspective view of another embodiment according to the present invention;

FIG. 3 is a schematic drawing showing a perspective sectional view of another embodiment according to the present invention;

FIG. 4 is a sectional view of another embodiment according to the present invention;

FIG. 5 is a schematic drawing showing a perspective sectional view of a further embodiment according to the present invention;

FIG. 6 is a sectional view of a further embodiment according to the present invention.

### DETAILED DESCRIPTION OF THE PREFERRED EMBODIMENT

In order to learn technical content, features, and functions of the present invention more clearly and completely, please refer to the following embodiments with related figures and reference signs.

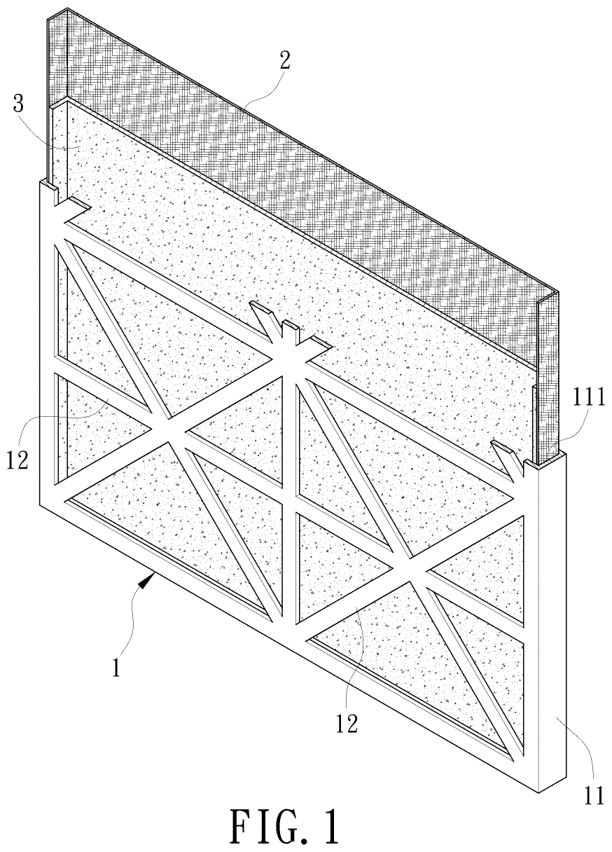

Refer to FIG. 1, a filter according to the present invention mainly includes a frame 1, a support mesh 2, and a filtering netlike body 3.

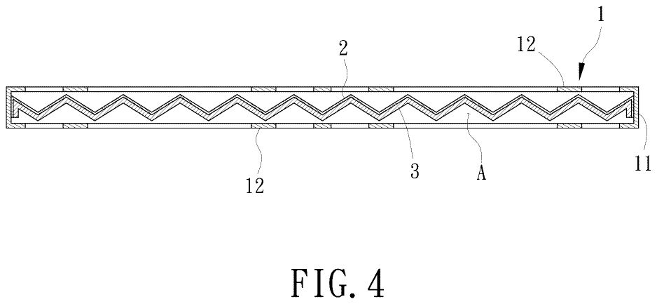

The frame 1 consists of a peripheral frame 11 and a plurality of support bars 12 connected to the peripheral frame 11. The peripheral frame 11 is in a rectangular shape, having a certain height and an opening 111 facing inward while being viewed from a section of the peripheral frame 1. The support bars 12 are disposed on an area surrounded by the peripheral frame 1 and located at each of two sides of the peripheral frame 1 correspondingly. The support bars 12 are intersected and connected with one another integrally. The peripheral frame 11 and the plurality of support bars 12 are also connected integrally. The peripheral frame 11 and the plurality of support bars 12 work together to define a cuboid having an internal space A therein (as shown in FIG. 4).

The support mesh 2 is mounted in the internal space A of the frame 1 and leaning against the support bars 12 at one side of the frame 1.

The filtering netlike body 3 is also arranged in the internal space A of the frame 1 and stacked over the support mesh 2. A periphery of the support mesh 2 and a periphery of the filtering netlike body 3 are both fixed by the peripheral frame 11 of the frame 1.

The frame 1, the support mesh 2, and the filtering netlike body 3 are made from waste fiber composite containing fibrous bodies and at least one adhesive. The fibrous bodies are coming from residual or recycled waste containing fibers which are pulverized into a form of fluffy cotton wool. Total weight of the waste fiber composite is given as 100 percent. A weight percent of the fibrous bodies is equal to and greater than 95% but less than 100% while the residual weight percent is of course the adhesive. A size of the fibrous body is ranging from 0.1 mm to 50 mm and the adhesive is acrylates copolymer.

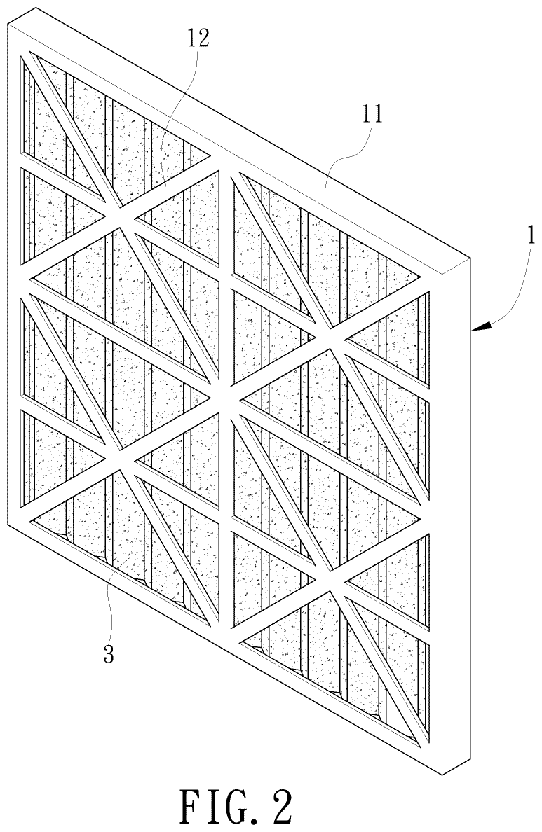

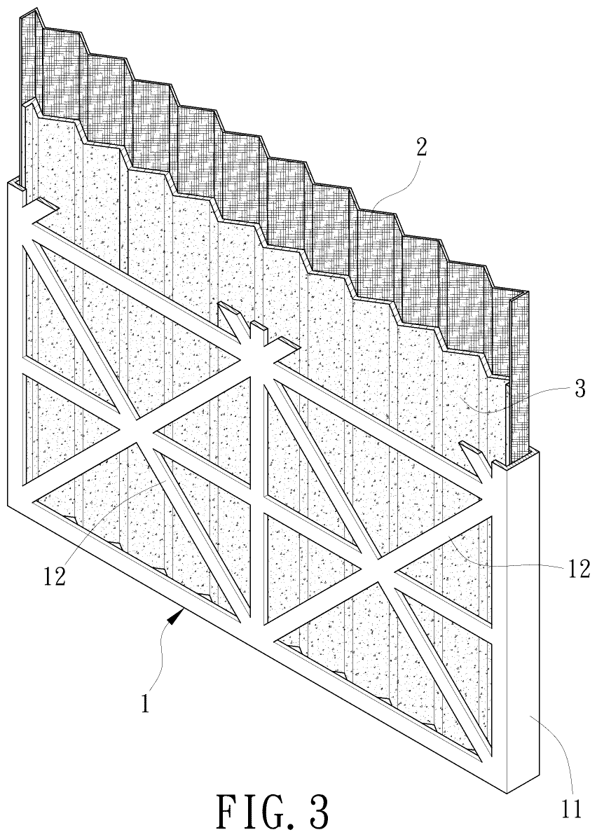

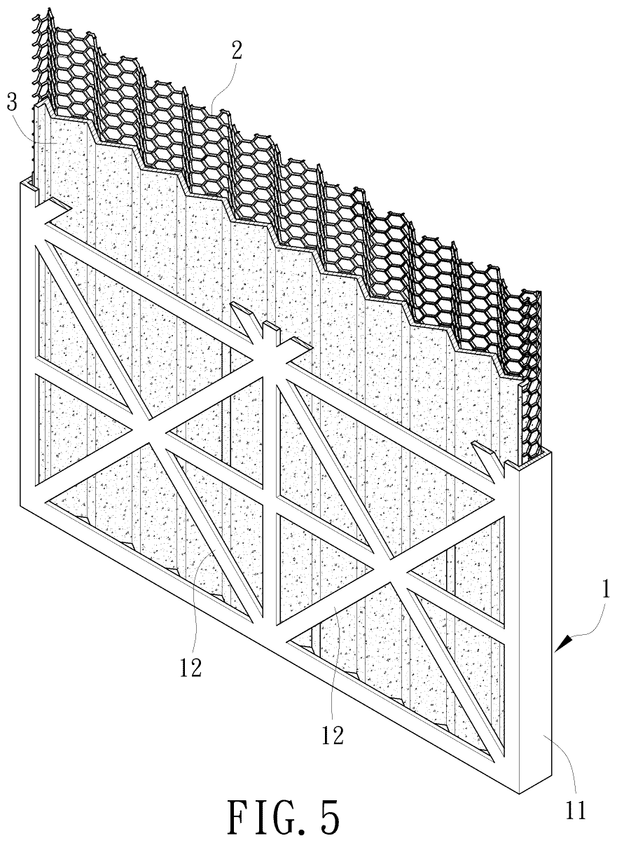

In the embodiment shown in FIG. 1, the support mesh 2 and the filtering netlike body 3 are both in a flat form while in the embodiment shown in FIG. 2-4, both the support mesh 2 and the filtering netlike body 3 are corrugated. As to the embodiment shown in FIG. 5, the support mesh 2 and the filtering netlike body 3 are also corrugated. The embodiment in FIG. 5 and the embodiment shown in FIG. 2-4 are different in hole shapes of the support mesh 2 formed. The support mesh 2 shown in FIG. 5 has a hexagonal hole.

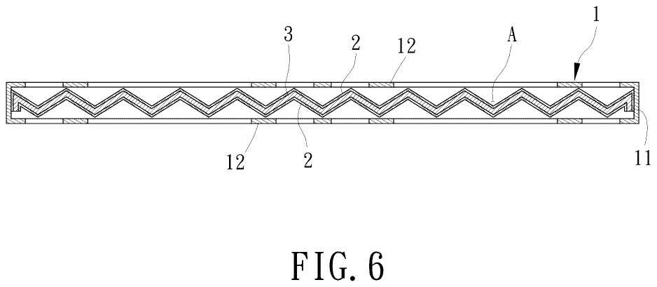

As the filter shown in FIG. 1-5, the support mesh 2 is stacked over one surface of the filtering netlike body 3. In the filter shown in FIG. 6, the support mesh 2 is stacked over each of two opposite surfaces of the filtering netlike body 3. That means the filtering netlike body 3 is clipped between two pieces of the support mesh 2.

The filter of the present invention can be applied to filter equipment used in fields of electronic computer rooms, cars, aircrafts, aviation, medicine, etc.

The preparation of the waste fiber composite includes the following steps. First pulverizing residual or recycled waste containing fibers into fibrous bodies look like fluffy cotton wool and having a size between 0.1 mm and 50 mm. Total weight of the waste fiber composite is given as 100 percent. Then mixing the fibrous bodies having the weight percent of no less than 95% but less than 100% with the adhesives having the residual weight percent to get the waste fiber composite.

Next providing the waste fiber composite obtained to an extrusion machine in which heating, melting, blending, and extrusion are performed to get finished products in strips, sheets, or plates.

A heating temperature of the extrusion machine is ranging from 90 degrees Celsius (° C.) to 180° C.

The finished products in sheets or plates are processed by secondary stamping to form frames, nets, cases, or laminate surfaces.

Moreover, the finished product in strips can be treated by pelletizing process to get plastic pellets or granules.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A filter comprising a frame, a support mesh, and a filtering netlike body;
the frame having a peripheral frame and a plurality of support bars; an area surrounded by the peripheral frame and the support bars arranged at the area and connected to the peripheral frame; the peripheral frame combined with the plurality of support bars to define a cuboid having an internal space;
the support mesh mounted in the space of the frame and leaning against the support bars;
the filtering netlike body also arranged in the space of the frame and stacked over the support mesh; a periphery of the support mesh and a periphery of the filtering netlike body both fixed by the peripheral frame of the frame;
wherein the frame, the support mesh, and the filtering netlike body are made from waste fiber composite; a total weight of the waste fiber composite is given as 100 percent; the waste fiber composite includes fibrous bodies with a weight percent of no less than 95% but less than 100% while the residual weight percent is at least one adhesive; the fibrous bodies are coming from residual or recycled waste containing fibers which are pulverized into a form of fluffy cotton wool; a size of the fibrous body is ranging from 0.1 mm to 50 mm and the adhesive is acrylates copolymer.

2. The filter as claimed in claim 1, wherein the support mesh is stacked over at least one surface of the filtering netlike body.

3. The filter as claimed in claim 2, wherein the support mesh is flat or corrugated.

4. The filter as claimed in claim 2, wherein the filtering netlike body is flat or corrugated.

5. The filter as claimed in claim 1, wherein the support mesh is stacked over each of two opposite surfaces of the filtering netlike body.

6. The filter as claimed in claim 5, wherein the support mesh is flat or corrugated.

7. The filter as claimed in claim 5, wherein the filtering netlike body is flat or corrugated.

8. The filter as claimed in claim 1, wherein the support mesh is flat or corrugated.

9. The filter as claimed in claim 1, wherein the filtering netlike body is flat or corrugated.
